(19) United States
(12) Patent Application Publication
(10) Pub. No.: US 2006/0114201 A1
(43) Pub. Date: Jun. 1, 2006

(54) Color temperature correction for phosphor converted leds

(75) Inventor: Chin Chang, Agoura Hills, CA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/540,670

(22) PCT Filed: Dec. 18, 2003
(86) PCT No.: PCT/IB03/06099

§ 371 Date: Jun. 24, 2005

Related U.S. Application Data
(60) Provisional application No. 60/436,859, filed on Dec. 26, 2002.

(51) Int. Cl. G09G 3/32

(52) U.S. Cl. 345/83

(57) ABSTRACT

Color correction in phosphor converted LEDs 520. A system and method provide color correction in emission spectra of a phosphor converted LED under PWM current drive. A modulation for a driving current signal is determined 810. A constant-magnitude current signal is modulated based on the determined modulation 820. The modulated current signal is applied to cause a color correction in the emission spectra 830. Apparatus to provide color correction in the emission spectra of a phosphor converted LED is provided 520. A color correction control circuit and a phosphor converted LED coupled to the control circuit are also provided 600.

The invention relates to methods operating light emitting diodes. More particularly the invention relates to techniques for color correction of light emitting diode emission spectra.

In the existing market, white LED lamps can be obtained from Nichia, LumiLeds and other opto-semiconductor manufactures. A single-chip white-light LED has great potential for the illumination market. White-light LEDs do not need complex control and driving circuits or color mixing optics and have an almost unified fabrication processes. The existing vehicles for single chip based LED white light generation are based on wavelength conversion technology using different types of fluorescent and phosphorescent materials. In principle, Blue or UV wavelength emission from the LED junction is used to pump a coated phosphor for spectral down-conversion. One example is the LumiLeds white LED with yellow phosphor.

Persistence of phosphors is generally characterized by approximately an exponential decay of the form e^{-at}, or of the power law t⁻ⁿ, or combinations of the two forms. In this discussion, without loss of generality, the phosphor light decay process is approximated using an equation of the form:

$${L}_{y} {ⅇ}^{\frac{t}{{T}_{P}}} , \qquad ( 1 )$$

where L_{y} is the initial phosphor light emission at the moment that blue or UV excitation is removed.

The phosphorescence time with persistence to the 10% level (denoted as decay time T_{pd}) varies from less than 1 μs to more than 1 second depending on the characteristics of the material used. In the existing high power PC-LED samples, the measured decay time constant (Tₚ) is less than 1 μs. Note that T_{pd}≈4Tₚ. It is common for phosphors exhibiting rapid rise and decay characteristics to have approximately 50% less brightness efficiency compared to the conventional medium level P20 yellow/green phosphor which usually have 10 μs to 100 ms of decay persistence time. From a data table of available PC-LEDs, it is observed that the phosphor rise time Tₚᵣ is usually a few times less than the decay time. The phosphor in a pc-white LED is ideally designed with persistence time in the range of approximately 100 μs to 10 ms.

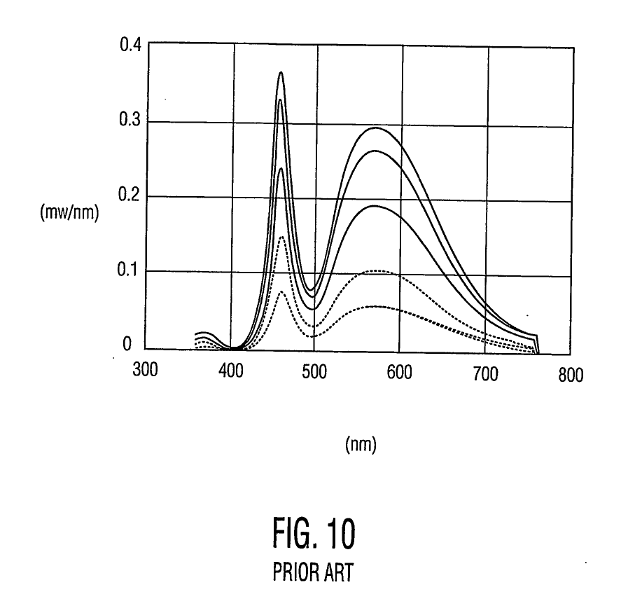

A typical power radiation spectrum of a white-light phosphor converted LED package under different DC driving currents is shown in FIG. 10. The first spectral hump at around 460 nm is due to the emission from the LED junction (InGaN) and the second hump with broader bandwidth with a peak around 500-600 nm is due to the emission from the yellow phosphor pumped by photons at around 46 nm.

Once the phosphor material is coated around the die dome during the manufacturing process, the relative emission spectra of a pc-white LED is fixed. Under normal DC current driving condition, the resulting white-light correlated color temperature (CCT) and color rendering index (CRI) are almost fixed at a particular junction operational temperature, say 25C. When the junction temperature changes from 25C to 80C, experimental results show that almost 800K CCT increase could result. The CCT shift is recognized as an unfortunate and undesirable property of phosphor-converted white LEDs. An LED CCT shift has a corresponding shifting effect on human color perception of objects illuminated by the LED.

Additionally, existing methods for altering the spectral content of multi-color LEDs emission require a resort to multiple variable-magnitude current sources, which results in increased complexity and cost. It would therefore be desirable to provide a method of utilizing existing pc-white LEDs to overcome these and other limitations.

The present invention is directed to a system and method to provide color correction in emission spectra of a phosphor converted LED (PC-LED) under pulse-width-modulation (PWM) current drive. A modulation for a driving current signal is determined. A constant magnitude current signal is modulated based on the determined modulation. The modulated current signal is applied to cause a color temperature correction in the emission spectra of the LED.

In accordance with another aspect of the invention an apparatus to provide color temperature correction in an emission spectra of a phosphor converted LED is provided. The apparatus includes a color correction control circuit and a phosphor converted LED coupled to the control circuit

The invention further includes a system to provide color temperature correction in an emission spectra of a constant current PWM driven phosphor converted white-light LEDs. The system comprises means for determining a driving current modulation to cause a color correction to the emission spectra, means for modulating a current signal with the determined modulation, and means for applying the modulated current signal to cause a color temperature correction in the emission spectra of the LED.

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

FIG. 1 shows a typical PC-LED driving current/blue light emission and the corresponding phosphor light output at a low frequency f₁ and T_{off}>>4Tₚ

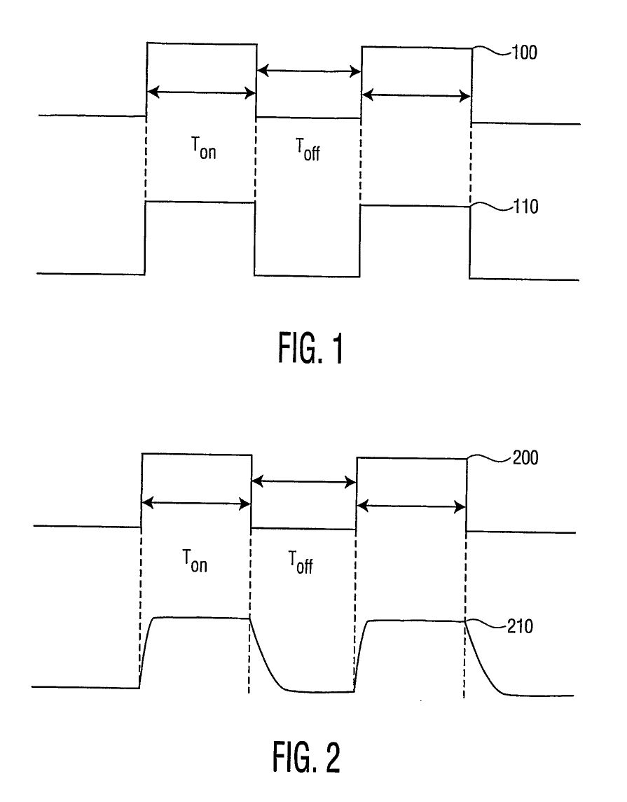

FIG. 2 shows typical PC-LED driving current/blue light emission and the corresponding phosphor light output at a mid-range frequency f₂ with T_{off}>4Tₚ.

FIG. 3 shows a typical PC-LED driving current/blue light emission and the corresponding phosphor light output at a mid-range frequency f₃ with T_{off}˜4Tₚ.

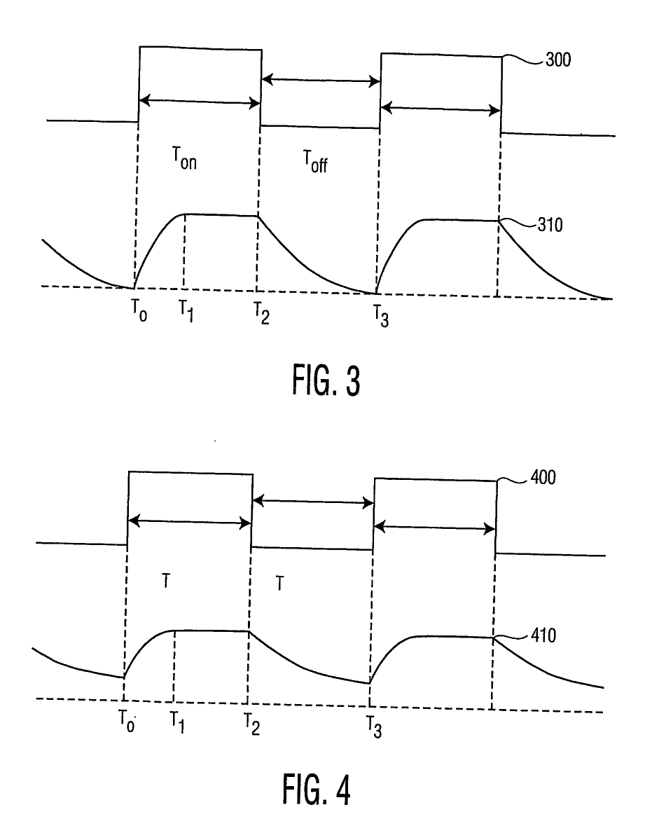

FIG. 4 shows a typical LED driving current/blue light emission and the corresponding phosphor light output at a mid-range frequency f₂ with T_{off}<4Tₚ

FIG. 5 is a block diagram of a color corrected phosphor-converted LED system in an embodiment of the invention.

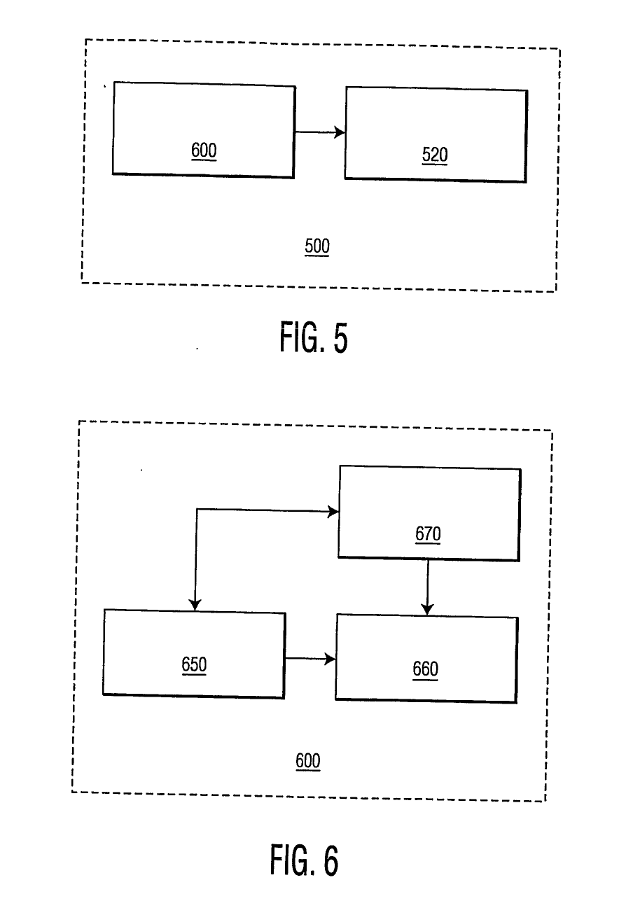

FIG. 6 is a block diagram of a color correction control circuit in an embodiment of the invention.

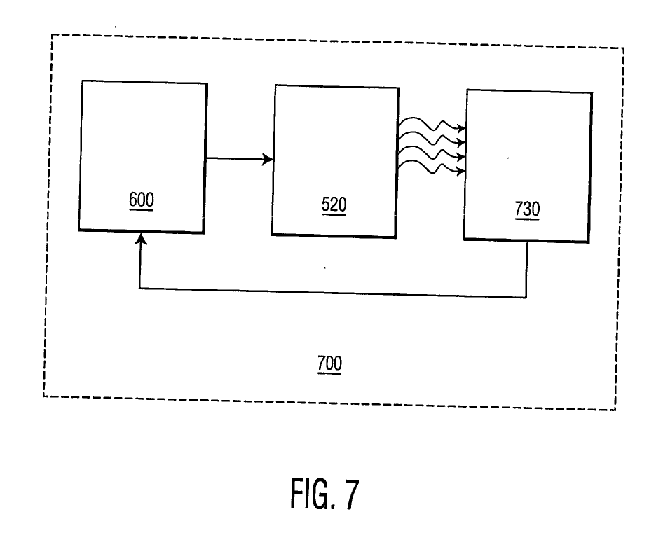

FIG. 7 is a block diagram of a color corrected phosphor-converted LED system with color sensing in another embodiment of the invention.

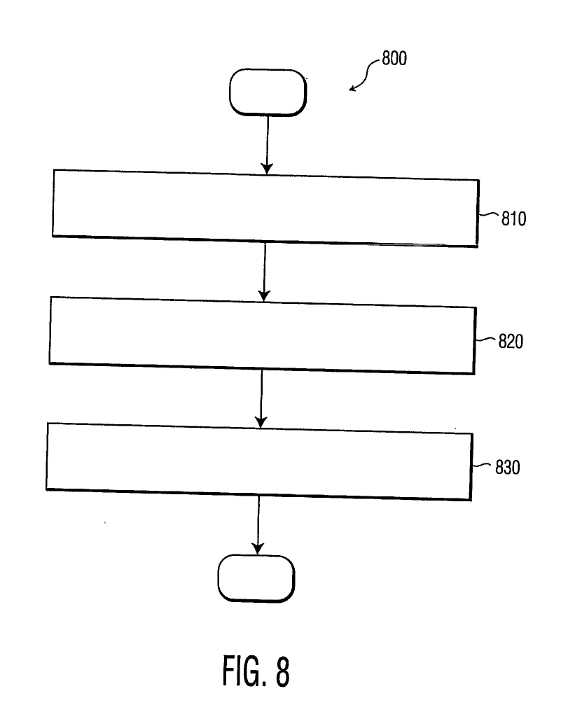

FIG. 8 shows a process for providing color correction in emission spectra of a phosphor converted LED under PWM current drive.

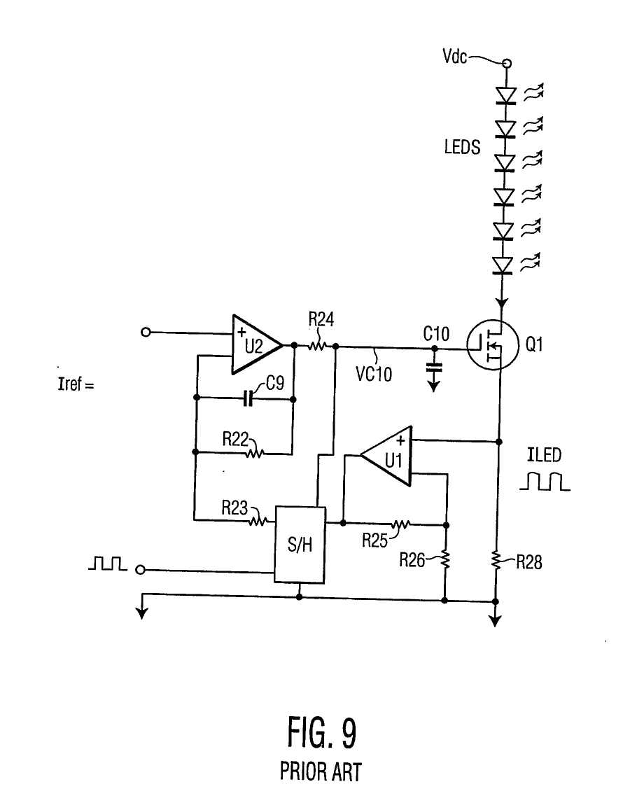

FIG. 9 shows a prior art simplified circuit embodiment for applying a modulation to a LED string.

FIG. 10 shows a prior art power radiation spectrum of a white light phosphor-converted LED.

FIG. 1 shows a typical driving current/blue light emission 100 and the corresponding phosphor light output 110 at a low frequency f₁ and T_{off}>>4Tₚ. Generally, a pc-white LED is driven under square wave current with constant amplitude and frequency f₀. The duty ratio of the drive signal is D=Tₒₙ/(T_{off}+Tₒₙ)=Tₒₙ/T=Tₒₙf₀. Correspondingly, the blue light emission from the LED junction generally follows the driving current signal when f₀<10 MHz assuming that the LED response time is under 50 ns. For the present example assume f₁ ≈200 Hz. Under this condition, the phosphor rise and decay time are so small compared with the off time T_{off} that they can be neglected. A color coordinate pair referencing a CIE color chart may be determined that describes the combined emissions of the LED junction and the phosphor. The white-light color point coordinates (x_{w},y_{w}) are determined by an equation of the form:

$$[ \begin{matrix}\frac{{x}_{w}}{{y}_{w}} \\ \frac{1}{{y}_{w}}\end{matrix} ] = [ \begin{matrix}\frac{{x}_{b}}{{y}_{b}} & \frac{{x}_{y}}{{y}_{y}} \\ \frac{1}{{y}_{b}} & \frac{1}{{y}_{y}}\end{matrix} ] * [ \begin{matrix}{I}_{b} \\ {I}_{y}\end{matrix} ] , \qquad ( 2 )$$

where (x_{b},y_{b}) and (x_{y},y_{y}) are the color coordinates of the blue light and yellow phosphor light respectively, with intensities:

$$\begin{matrix}{I}_{b} = \frac{{L}_{b} {T}_{on} {f}_{0}}{{L}_{b} {T}_{on} {f}_{0} + {L}_{y} {T}_{on} {f}_{0}} , and & ( 3 ) \\ {I}_{y} = \frac{{L}_{y} {T}_{on} {f}_{0}}{{L}_{b} {T}_{on} {f}_{0} + {L}_{y} {T}_{on} {f}_{0}} , respectively . & ( 4 )\end{matrix}$$

FIGS. 2 and 3 show typical LED driving current/blue light emissions and the corresponding phosphor light outputs 210, 310 respectively at mid-range frequency f_{mid}, such as f₂ 200 with T_{off}>4Tₚ, and f₃ 300 with T_{off˜}4Tₚ. In the middle frequency range, the phosphor light decay process starts to have an effect on the LED white-light color point. While the blue light intensity is maintained as L_{b}Tₒₙf₀, and the yellow light intensity is represented by the equation in the form:

$${I}_{y} ( {f}_{mid} ) = {f}_{0} {L}_{y} [ {T}_{2} - \frac{{T}_{p}}{α} ( 1 - {ⅇ}^{- \frac{{αT}_{1}}{{T}_{p}}} ) + {T}_{p} ( 1 - {ⅇ}^{- \frac{{T}_{3} - {T}_{2}}{{T}_{p}}} ) ] , \qquad ( 5 )$$

with α>1.

The white-light color points (x_{w}y_{w}) may then be determined based on equations (2), (3) and (5).

FIG. 4 shows a typical LED driving current/blue light emission 400 and the corresponding phosphor light output 410 at a higher frequency f₄ with T_{off}<4Tₚ. In the higher frequency range, the phosphor light decay process has a substantial effect on the LED white-light color point. While the blue light intensity is still maintained as L_{b}Tₒₙf₀, the yellow light intensity becomes the linear combination of a prior shift such as discussed in FIGS. 2 and 3 and a further increase due to the higher frequency drive signal. The yellow light intensity is then represented by the equation in the form:

$${I}_{y} ( {f}_{high} ) = {f}_{0} {L}_{y} [ {T}_{2} - \frac{{T}_{p}}{α} ( 1 - {ⅇ}^{- \frac{{αT}_{1}}{{T}_{p}}} ) + {T}_{p} ( 1 - {ⅇ}^{- \frac{{T}_{3} - {T}_{2}}{{T}_{p}}} ) ] + {I}_{{y}_{0}} , \qquad ( 6 )$$

with α>1.

The white-light color coordinate points (x_{w},y_{w}) may again be determined based on equation (2), (3) and (6). Note that since the PWM driving current duty ratio is independent of the driving current frequency, the duty cycle may be alternatively used to modulate a CCT color shift with a corresponding increase in the total light output of the LED. Furthermore it is possible to employ both duty cycle and frequency modulation to the constant magnitude PWM current signal to maintain a constant light output while compensating for a color temperature shift. In the described manner, it is possible to modulate the magnitude and shape of the emission spectra of a phosphor converted LED using a modulated PWM current signal.

In the following descriptions, the term “coupled” means either a direct electrical connection between the things that are described or a connection through one or more passive or active components. The phrase “color coordinates” means “white-light color coordinates.”

FIG. 5 is a block diagram of a color corrected phosphor-converted LED system in an embodiment of the invention. FIG. 5 shows a color corrected PC-LED system 500 comprising a color correction control circuit 600, and a phosphor-converted LED 520. In FIG. 5, the color correction control circuit 600 (hereinafter, control circuit) is shown coupled to the phosphor-converted LED 520 (hereinafter, PC-LED.) An embodiment of the control circuit 600 will later be described in detail in reference to FIG. 6.

The control circuit 600 is a generally a combination of systems and devices that provides color correction control to the PC-LED 520. The control circuit 600 is arranged when operational to determine a modulation for a driving current signal, modulate a constant magnitude current signal based on the determined modulation, and then apply the modulated current signal to the PC-LED 520 to cause a color correction in the output emission spectra of the PC-LED 520.

The PC-LED 520 is any phosphor-converted LED suitable for color correction. In particular, the PC-LED 520 generally has an operational temperature induced CCT shift. However, the invention may be applied to a PC-LED 520 for color conversion when any CCT shift is desired, whether the shift is to reverse an operational temperature-induced CCT shift or not. For example, a low-cost white-light PC-LED 520 may have an undesirable color coordinate set for a particular application such as reading illumination or nightlights, and therefore a color adjustment to the LED output may be accomplished using the control circuit 600 to either shift the CCT up or down depending on the application. It should be noted that while the present discussion applies to phosphor converted white-light LEDs, the invention may be applied to any PC-LED, including PC-LEDs that are designed to have spectral output other than white light.

FIG. 6 is a block diagram of a color correction control circuit in an embodiment of the invention. FIG. 6 shows a color correction control circuit 600 comprising a power supply 650, a PWM modulator 660, and a processor control system 670. The power supply 650 is shown coupled to the processor control system 670 and the PWM modulator 660. The processor control system 670 is also shown coupled to the PWM modulator 660. Additional components (not shown) may be included in the control circuit 600 such as voltage and current regulation components, temperature monitoring apparatus, user controls and the like. The power supply 650 selectively couples regulated or unregulated power to a load, and may include various regulation circuits.

In operation, the power supply 650 is selectively coupled to the PWM modulator 660 based on control signals from the processor control system 670. Various means and methods for generating and controlling a pulse-width modulated current signal and coupling the signal to a load will be known to those skilled in the art, and will not be elaborated.

The processor control system 670 is a control system generally comprised of a processor such as a microcontroller (not shown) and various connected components such as, for example, input/output interfaces, memory (not shown) containing stored processor-executable instructions (not shown) and stored data (not shown). The processor control system may have a memory containing predetermined reference data such as, for example, color coordinate points determined according to equation (1) referenced to an LED operational temperature curve. In one embodiment (not shown), the processor control system 670 is configured to receive LED operational temperature information to allow LED temperature-based color correction based on a lookup table of calculated color coordinates.

In operation, the processor control system 670 is configured to determine a modulation scheme to cause a CCT shift in the output spectrum of an LED such as PC-LED 520. The processor control system 670 is enabled to determine a frequency and/or duty-cycle modulation to a PWM driving current signal. In one embodiment, the processor control system 670 may collect measured data in real-time based on the output of an LED, such as is depicted in FIG. 7. In one embodiment, the processor control system 670 determines a modulation through a calculation of color coordinate pairs according to equation (1) based on various data such as PC-LED 520 output intensity. Various configurations to implement a processor control system 670 will be known to those skilled in the art, and will not be elaborated.

A skilled practitioner will recognize that other circuit embodiments for implementing the invention are possible, such as the simplified circuit embodiment for applying a modulation to an LED string as shown in FIG. 9.

FIG. 7 is a block diagram of a color corrected phosphor-converted LED system with color sensing in another embodiment of the invention. FIG. 7 shows a color corrected PC-LED system 700, comprising a color correction control circuit 600, a phosphor-converted LED 520 and a color sensing system 730. In FIG. 7, the color correction control circuit 600 is shown coupled to the phosphor-converted LED 520. The phosphor-converted LED 520 is shown radiating light to the color sensing system 730.

The color corrected system 700 comprises the same elements as the color corrected system 500 of FIG. 5 with the addition of the color sensing system 730. The color sensing system is any system designed to sense color in response to a light source such as PC-LED 520.

In operation, the color sensing system 730 is configured to sense the CCT of the PC-LED 520 light emissions and to provide a color signal to the color correction circuit based on the sensed light emissions. The color sensing system may send the color signal in any form such as a digitally modulated or analog signal representing the spectral content of the PC-LED 520 light emissions. A feedback control loop between the color sensing system 730 and the control circuit 600 is then capable to control the CCT of the PC-LED 520 emission spectra over time and under variable parameters. Various other configurations to implement a color sensing system 730 in the color corrected system 700 will be known to those skilled in the art, and will not be elaborated.

In the following process description one or more steps may be combined or performed simultaneously without departing from the invention.

FIG. 8 shows a process for providing color correction in emission spectra of a phosphor converted LED under PWM current drive. Process 800 begins in step 810. In step 810, a modulation is determined for a driving current signal. The modulation is generally a frequency or duty ratio modulation to be applied to a square wave PWM current signal. The modulation is determined at any time. For instance, the modulation may be determined in response to a data signal, a turn-on cycle or user input. The determination is generally performed by a system such as a color correction control circuit as in FIGS. 5, 6 and 7. Alternatively, the modulation determination may be predetermined based on a manufacturer data according to equation (1), and provided in a lookup table for reference by a processor, such as processor control system 670. A modulation determination is made based on criteria such as a desired CCT of a PC-LED under varying operational conditions such as temperature, total light output, and phosphor composition. A modulation may be determined by simultaneously solving equations (2), (3), (4), or (5) with equation (1) where a coordinate pair (x_{w},y_{w}) is pre-selected.

In step 820, a constant-magnitude current signal is modulated based on the modulation determined in step 810. The constant magnitude current signal is generally provided by a regulated power supply, such as power supply 650. In one embodiment, a processor control system 670 selectively couples power to a PWM modulator 660 from a power supply 650 to generate a modulated current signal based on the modulation determined in step 810. Other methods for modulating a constant magnitude PWM current signal with a current and/or frequency modulation will be apparent to those skilled the art and will not be further elaborated.

In step 830, the modulated current signal is applied to cause a color correction in the emission spectra of a PC-LED. The modulated current signal is applied to an LED such as the PC-LED 520. In one embodiment, the current signal modulated in step 820 is delivered from a color correction circuit 600 to the PC-LED 520. The modulated current signal is applied at any time after the current signal is modulated in step 820. Applying the modulated current signal to PC-LED 520 accomplishes a correction to a CCT shift due to temperature induces drift, or for another purpose. In one embodiment, the applied current signal includes both a frequency and a duty ratio modulation to allow CCT correction without affecting the total light output of the PC-LED to which the current signal is applied.

While the preferred embodiments of the invention have been shown and described, numerous variations and alternative embodiments will occur to those skilled in the art. Accordingly, it is intended that the invention be limited only in terms of the appended claims.

1. A method to provide color temperature correction in emission spectra of a phosphor converted LED under PWM current drive comprising:
determining a modulation for a driving current signal 810;
modulating a constant magnitude current signal based on the determined modulation 820; and
applying the modulated current signal to cause a color temperature correction in the emission spectra 830 of the LED.

2. The method of claim 1 wherein determining a modulation 810 includes determining a first LED 520 emission spectra color coordinate set and a second LED 520 emission spectra color coordinate set wherein the first color coordinate set represents LED 520 emission spectra at a first LED 520 operational temperature and the second color coordinate set represents a CCT shift in the LED 520 emission spectra due to operation of the LED 520 at a second operational temperature.

3. The method of claim 2 wherein the current signal modulation is determined 810 such that applying the determined current signal modulation 830 to the LED 520 causes the LED 520 emission spectra at the first color coordinate set to be substantially constant as the LED 520 operational temperature changes from the first LED 520 operational temperature to the second LED 520 operational temperature.

4. The method claim 1 wherein the modulation includes changing the current signal frequency.

5. The method of claim 1 wherein the modulation includes changing the current signal duty-cycle.

6. The method of claim 5 wherein the total light output of the LED 520 is changed responsive to the changing of the current signal duty cycle.

7. The method of claim 5 wherein the current signal frequency is changed to maintain a constant total light output of the LED 520.

8. The method of claim 1 wherein applying the modulated current signal 830 includes selectively coupling a power supply 650 to a phosphor converted LED 520 based on the determined modulation.

9. The method of claim 8 wherein the LED 520 is a phosphor converted white light LED.

10. The method of claim 9 wherein the LED 520 junction emission intensity is substantially constant while the phosphor emission intensity is increased responsive to the current signal modulation.

11. An apparatus to provide color temperature correction in an emission spectra of a phosphor converted LED 520 comprising:
a color correction control circuit 600; and
a phosphor converted LED 520 coupled to the control circuit 600
wherein the control circuit is configured to determine a modulation 810 for an LED 520 driving current signal modulate a constant magnitude current signal based on the determined modulation 820 and apply the modulated current signal 830 to the LED 520 to cause a color temperature correction in the emission spectra of the LED 520.

12. The apparatus of claim 11 wherein the control circuit 600 includes a constant-current magnitude pulse width modulator circuit 660 having configurable frequency and duty cycle.

13. The apparatus of claim 12 wherein the control circuit 600 includes a power supply 650 selectively arranged to deliver power to the pulse width modulator circuit 660.

14. The apparatus of claim 11 wherein the control circuit 600 includes a processor control system 670.

15. The apparatus of claim 14 wherein the processor control system 670 is enabled to control the steps of:
determining a modulation for an LED 520 driving current signal 810;
modulating a constant magnitude current signal based on the determined modulation 820; and
applying the modulated current signal 830 to the LED 520 to cause a color temperature correction in the emission spectra of the LED 520.

16. The apparatus of claim 15 wherein determining a modulation 810 includes
determining a first LED 520 emission spectra color coordinate set and a second LED 520 emission spectra color coordinate set wherein the first color coordinate set represents LED 520 emission spectra at a first LED 520 operational temperature and the second color coordinate set represents a CCT shift in the LED 520 emission spectra due to operation of the LED 520 at a second operational temperature and wherein a current signal modulation is determined 810 such that applying the determined current signal modulation 830 to the LED 520 causes the LED 520 emission spectra at the first color coordinate set to be substantially constant as the LED 520 operational temperature changes from the first LED 520 operational temperature to the second LED 520 operational temperature.

17. The apparatus of claim 11 wherein the LED 520 is a white light phosphor converted LED.

18. The apparatus of claim 15 wherein the LED 520 is an InGaN phosphor converted white-light LED 520.

19. A system to provide color temperature correction in an emission spectra of a constant current PWM driven phosphor converted white-light LED 520 comprising:
means for determining a driving current modulation to cause a color correction to the emission spectra 810;
means for modulating a current signal with the determined modulation 820;
means for applying the modulated current signal to cause a color temperature correction in the emission spectra 830 of the LED.
